(19) United States
(12) Patent Application Publication
(10) Pub. No.: US 2015/0138709 A1
(43) Pub. Date: May 21, 2015

(54) SEPARABLE ELECTRONIC DEVICE

(71) Applicant: PEGATRON CORPORATION, Taipei City (TW)

(72) Inventors: Hong-Yi CHEN, Taipei City (TW); Chien-Chen LIN, Taipei City (TW); Ching-Hao YU, Taipei City (TW)

(73) Assignee: PEGATRON CORPORATION, Taipei City (TW)

(21) Appl. No.: 14/159,447

(22) Filed: Jan. 21, 2014

(30) Foreign Application Priority Data
Nov. 15, 2013 (TW) 102221405

(51) Int. Cl. G06F 1/16

(52) U.S. Cl. CPC G06F 1/1601; G06F 1/1605
USPC 361/679.22

(57) ABSTRACT

A separable electronic device includes a display panel and a computer host. The display panel has a backside and a first connecting portion. The first connecting portion is provided at the backside. The computer host has a second connecting portion. The second connecting portion is detachably connected with the first connecting portion.

### CROSS-REFERENCE TO RELATED APPLICATIONS

This Non-provisional application claims priority under 35 U.S.C. §119(a) on Patent Application No(s). 102221405 filed in Taiwan, Republic of China on Nov. 15, 2013, the entire contents of which are hereby incorporated by reference.

### BACKGROUND

1. Technology Field

The invention relates to an electronic device and, in particular, to a separable electronic device.

2. Related Art

Currently, the computers have been widely used in various fields. From the popularity of personal computers to industrial computers, computers have become an indispensable tool for modern people.

Due to the advance of the semiconductor manufacturing process which promotes the miniaturization of components, all-in-one desktop computers have been appeared in the market. “All-in-one” means that the computer host and the display are integrated in a single housing and can operate their original functions. Although an all-in-one desktop computer occupies less space and is easier to be transported, it is difficult to be upgraded by the user along with the advance of the technology and the need of the user since the computer host and the display are integrated in a single housing. The manufacturer also needs complex tools to maintain an all-in-one desktop computer, which is inconvenient to change the display to a different size.

### SUMMARY

The invention discloses a separable electronic device. According to an embodiment of the invention, the separable electronic device includes a display panel and a computer host. The display panel has a backside and a first connecting portion. The first connecting portion is provided at the backside. The computer host has a second connecting portion. The second connecting portion is detachably connected with the first connecting portion.

According to an embodiment of the invention, the display panel further includes a recess. The recess is provided at the backside, and the shape of the recess corresponds to the shape of the computer host.

According to an embodiment of the invention, when the second connecting portion is connected with the first connecting portion, at least a part of the computer host is accommodated in the recess.

According to an embodiment of the invention, the display panel includes a first fastening portion, the computer host includes a second fastening portion, and when the second connecting portion is connected with the first connecting portion, at least a part of the computer host is accommodated in the recess and the first fastening portion is connected with the second fastening portion.

According to an embodiment of the invention, the display panel includes a first electronic module, and the first electronic module includes a display unit, a video camera, a microphone, a touch-control unit or a combination thereof.

According to an embodiment of the invention, the first connecting portion is electrically connected with the first electronic module.

According to an embodiment of the invention, the computer host includes a second electronic module, and the second electronic module includes a central processing unit, an image processing unit, a memory unit, a storage unit or a combination thereof.

According to an embodiment of the invention, the second connecting portion is electrically connected with the second electronic module.

According to an embodiment of the invention, the first connecting portion is a PCIE (peripheral component interconnect express) golden finger and the second connecting portion is a PCIE slot.

To sum up, according to the separable electronic device of the invention, since the second connecting portion is detachably connected with the first connecting portion, the user may change the display panel 1 to a different size easily. The objectives of low cost, diversity and easy maintenance can be achieved.

### BRIEF DESCRIPTION OF THE DRAWINGS

FIG. 1 is a schematic diagram showing a separable electronic device before being assembled according to an embodiment of the invention.

FIG. 2 is a schematic diagram showing a separable electronic device after being assembled according to an embodiment of the invention.

FIG. 3 is a schematic diagram showing a separable electronic device before being assembled according to another embodiment of the invention.

### DETAILED DESCRIPTION OF THE INVENTION

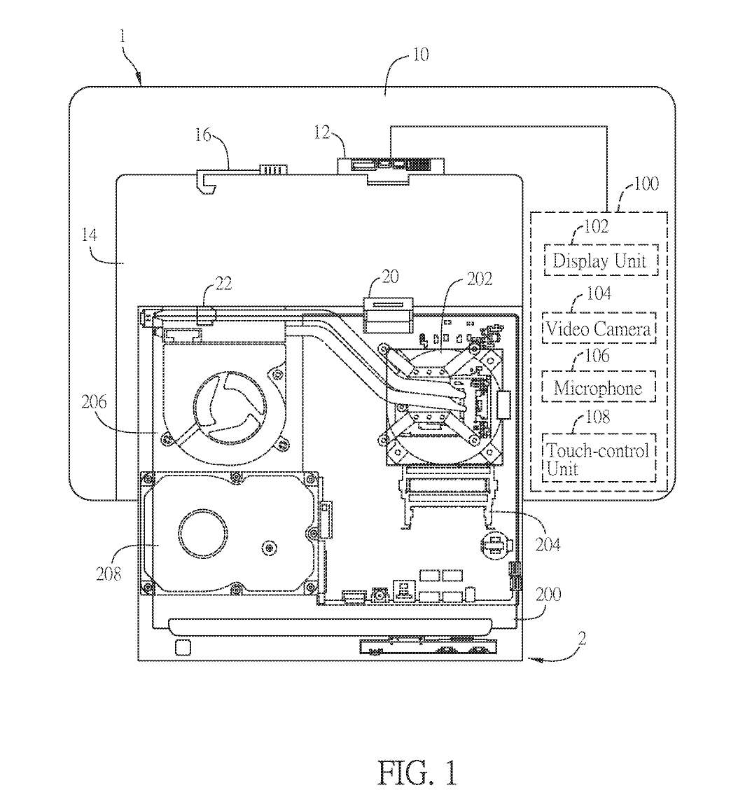

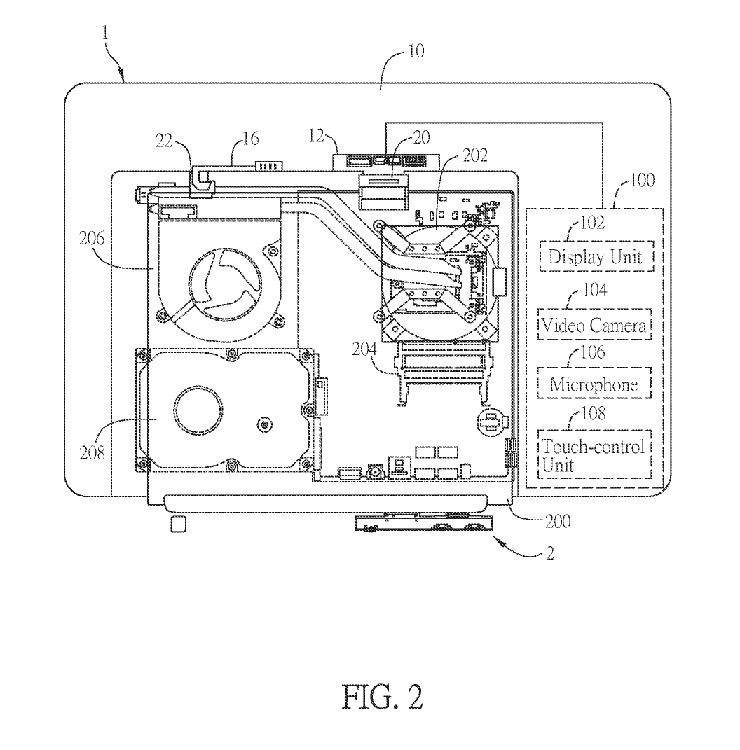

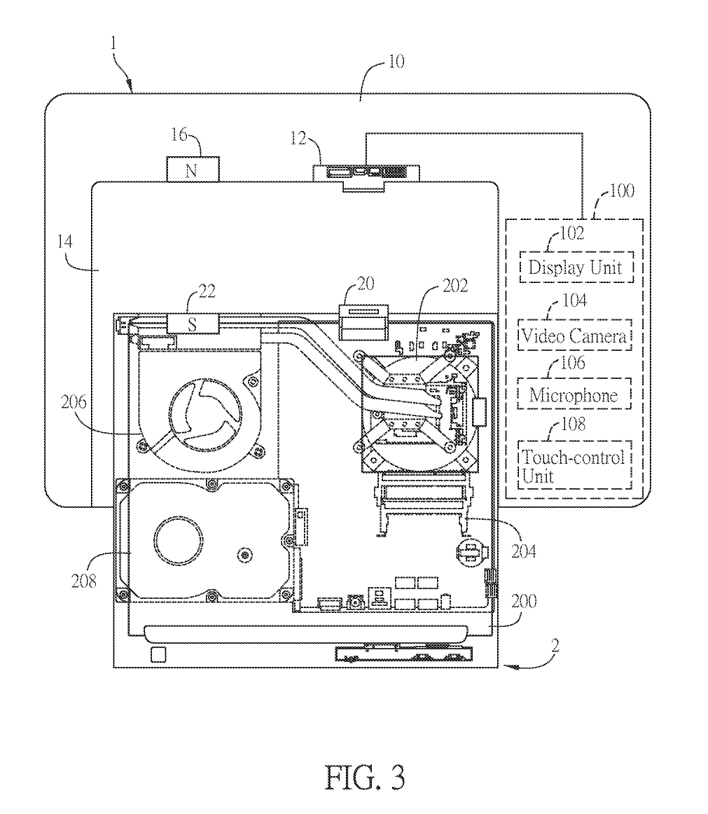

FIG. 1 is a schematic diagram showing a separable electronic device before being assembled according to an embodiment of the invention. FIG. 2 is a schematic diagram showing a separable electronic device after being assembled according to an embodiment of the invention. FIG. 3 is a schematic diagram showing a separable electronic device before being assembled according to another embodiment of the invention. Please refer to FIG. 1 and FIG. 2 simultaneously. The separable electronic device includes a display panel 1 and a computer host 2. The display panel 1 has a backside 10 and a first connecting portion 12 provided at the backside 10. The computer host 2 has a second connecting portion 20. The second connecting portion 20 is detachably connected with the first connecting portion 12 to achieve the electrical connection between the display panel 1 and the computer host 2 so that the display panel 1 or the computer host 2 of different specifications can be changed conveniently.

The first connecting portion 12 may be a PCIE (peripheral component interconnect express) golden finger and the second connecting portion 20 may be a PCIE slot. The first connecting portion 12 and the second connecting portion 20 may also be connected via the USB (universal serial bus) specification or other electrical connecting means commonly used in the art. The invention is not limited therein.

The display panel 1 may further include a recess 14. The recess 14 is provided at the backside 10, and the shape of the recess 14 corresponds to the shape of the computer host 2. The shape of the recess 14 may be the same to or similar to all or a part of the shape of the computer host 2. The invention is not limited therein.

As shown in FIG. 2, when the second connecting portion 20 is connected with the first connecting portion 12, at least a part of the computer host 2 is accommodated in the recess 14. That is, when the user or the manufacturer wants to combine the display panel 1 with the computer host 2, he or she only needs to connect the second connecting portion 20 to the first connecting portion 12 so that all or a part of the computer host 2 is accommodated in the recess 14.

The display panel 1 includes a first fastening portion 16, and the computer host 2 includes a second fastening portion 22. When the second connecting portion 20 is connected with the first connecting portion 12, at least a part of the computer host 2 is accommodated in the recess 14, and the first fastening portion 16 is connected with the second fastening portion 22.

As shown in FIG. 1 and FIG. 2, the first fastening portion 16 and the second fastening portion 22 may be a pair of latching devices. The first fastening portion 16 and the second fastening portion 22 may be a hook and a slot, respectively. When the second connecting portion 20 is connected with the first connecting portion 12, the hook and the slot are engaged with each other to fasten the display 1 to the computer host 2.

As shown in FIG. 3, the first fastening portion 16 and the second fastening portion 22 may be an N-pole magnet and an S-pole magnet, respectively. When the second connecting portion 20 is connected with the first connecting portion 12, the N-pole magnet and the S-pole magnet attract each other to fasten the display panel 1 to the computer host 2. The function of the first fastening portion 16 and the second fastening portion 22 is to fasten the display panel 1 to the computer host 2. A person having ordinary skill in the art may fasten the display panel 1 to the computer host 2 by other means, and therefore the invention is not limited therein.

The display panel 1 includes a first electronic module 100. The first electronic module 100 includes a display unit 102, a video camera 104, a microphone 106, a touch-control unit 108 or a combination thereof. The display unit 102 may be used to display an output picture or a user interface to let the user input instructions via the video camera 104, the microphone 106 or the touch-control unit 108 to achieve interactive functionalities.

The first connecting portion 12 is electrically connected with the first electronic module 100. That is, the first connecting portion 12 is electrically connected with the components of the first electronic module 100 (the display unit 102, the video camera 104, the microphone 106, the touch-control unit 108 or a combination thereof), and integrates the signals from the components in the first electronic module 100. The components in the first electronic module 100 may exchange information with each other by the first connecting portion 12.

The computer host 2 includes a second electronic module 200. The second electronic module 200 includes a central processing unit 202, an image processing unit 204, a memory unit 206, a storage unit 208 or a combination thereof. The computer host 2 performs functions such as logical operations, program instructions and signal processing via the central processing unit 202, the image processing unit 204, the memory unit 206, the storage unit 208 or a combination thereof.

The second connecting portion 20 is electrically connected with the second electronic module 200. That is, the second connecting portion 20 is electrically connected with the components of the second electronic module 200 (the central processing unit 202, the image processing unit 204, the memory unit 206, the storage unit 208 or a combination thereof), and the second connecting portion 20 integrates the signals from the components of the second electronic module 200. The components of the second electronic module 200 may exchange information with each other by the second connecting portion 20. Signals may be transmitted between the display panel 1 and the computer host 2 via the first connecting portion 12 and the second connection portion 20.

According to the separable electronic device of the embodiment, since the second connecting portion 20 is detachably connected with the first connecting portion 12 when assembling the display panel 1 and the computer host 2, the user or the manufacturer may change the display panel 1 to a different size easily. Furthermore, since the first connecting portion 12 and the second connecting portion 20 integrate the signals of the display panel 1 and the computer host 2, respectively, and signals are also transmitted between the display panel 1 and the computer host 2 via the first connecting portion 12 and the second connecting portion 20, the objectives of low cost, diversity and easy maintenance can be achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A separable electronic device, comprising:
a display panel having a backside and a first connecting portion, the first connecting portion being provided at the backside; and
a computer host having a second connecting portion, the second connecting portion being detachably connected with the first connecting portion.

2. The separable electronic device according to claim 1, wherein the display panel further comprises a recess, the recess is provided at the backside, and the shape of the recess corresponds to the shape of the computer host.

3. The separable electronic device according to claim 2, wherein when the second connecting portion is connected with the first connecting portion, at least a part of the computer host is accommodated in the recess.

4. The separable electronic device according to claim 2, wherein the display panel comprises a first fastening portion, the computer host comprises a second fastening portion, and when the second connecting portion is connected with the first connecting portion, at least a part of the computer host is accommodated in the recess and the first fastening portion is connected with the second fastening portion.

5. The separable electronic device according to claim 1, wherein the display panel comprises a first electronic module, and the first electronic module includes a display unit, a video camera, a microphone, a touch-control unit or a combination thereof.

6. The separable electronic device according to claim 5, wherein the first connecting portion is electrically connected with the first electronic module.

7. The separable electronic device according to claim 1, wherein the computer host comprises a second electronic module, and the second electronic module includes a central processing unit, an image processing unit, a memory unit, a storage unit or a combination thereof.

8. The separable electronic device according to claim 7, wherein the second connecting portion is electrically connected with the second electronic module.

9. The separable electronic device according to claim 1, wherein the first connecting portion is a PCIE (peripheral component interconnect express) golden finger and the second connecting portion is a PCIE slot.
